(19) United States
(12) Patent Application Publication
(10) Pub. No.: US 2026/0065774 A1
(43) Pub. Date: Mar. 5, 2026

(54) TRAFFIC CONTROL MANAGEMENT SYSTEM, TRAFFIC SIGNAL CONTROL SYSTEM FOR A TRAFFIC CONTROL MANAGEMENT SYSTEM, AND COMPUTER-IMPLEMENTED METHODS FOR CONTROLLING A TRAFFIC LIGHT APPARATUS

(71) Applicant: Circuits Evolved, Flower Mound, TX (US)

(72) Inventors: Brian Payne, Coppell, TX (US); Everett Ivy, Flower Mound, TX (US); Luke Adams, North Richland Hills, TX (US); James Graham, Flower Mound, TX (US)

(73) Assignee: Circuits Evolved, Flower Mound, TX (US)

(21) Appl. No.: 18/816,491

(22) Filed: Aug. 27, 2024

(51) Int. Cl. G08G 1/08; G08G 1/01

(52) U.S. Cl. CPC G08G 1/08; G08G 1/0116

(57) ABSTRACT

A traffic control management system includes a secondary traffic signal control system operable to perform operations including: training ML models based on a training data set comprising traffic data to thereby obtain trained ML models, capturing traffic sensor data at the one or more neighboring/adjacent traffic intersections, deploying the trained ML models to predict traffic flow and determine an optimum traffic signal state at the traffic intersection based on the captured traffic sensor data, executing virtual emulation code to virtually emulate the traffic light apparatus and thereby obtain a virtually emulated traffic light apparatus, and autonomously controlling operation of the traffic light apparatus based on the determined optimum traffic signal state by linking a primary traffic signal controller of the primary traffic signal control system to the virtually emulated traffic light apparatus.

### TECHNICAL FIELD

The present disclosure relates to a traffic control management system, a traffic signal control system for such a traffic control management system, a computer program product, and one or more computer-implemented methods for controlling a traffic light apparatus mounted at a traffic intersection located at a geographic location having one or more neighboring/adjacent traffic intersections.

### BACKGROUND

A traffic intersection includes one or more traffic light apparatus that are controlled by a traffic signal control. Traffic control management systems, however, are prone to inefficiencies in failing to adapt to traffic flow in a way to alleviate traffic delays.

### SUMMARY

The present disclosure relates to a traffic control management system, a traffic signal control system for such a traffic control management system, a computer program product, and one or more computer-implemented methods for controlling a traffic light apparatus mounted at a traffic intersection located at a geographic location having one or more neighboring/adjacent traffic intersections. The traffic control management system and traffic signal control system are operable to regulate vehicle and pedestrian movement at one or more neighboring/adjacent traffic intersections in a manner that facilitates efficient traffic flow and traffic safety.

In accordance with one example implementation, a traffic control management system comprises one or more of the following: a primary traffic signal control system to operatively control a traffic light apparatus mounted at a traffic intersection located at a geographic location having one or more neighboring/adjacent traffic intersections; a secondary traffic signal control system comprising one or more processors and a non-transitory memory coupled to the one or more processors, the non-transitory memory including a set of instructions, which when executed by the one or more processors, cause the one or more processors to perform operations including: training a machine learning (ML) model based on a training data set comprising traffic data to thereby obtain a trained ML model, capturing traffic sensor data at the one or more neighboring/adjacent traffic intersections, deploying the trained ML model to determine an optimum traffic signal state at the traffic intersection based on the captured traffic sensor data, executing virtual emulation code to virtually emulate the traffic light apparatus and thereby obtain a virtually emulated traffic light apparatus, and autonomously controlling operation of the traffic light apparatus based on the determined optimum traffic signal state by linking a primary traffic signal controller of the primary traffic signal control system to the virtually emulated traffic light apparatus.

In accordance with one example implementation, a traffic control management system comprises one or more of the following: a primary traffic signal control system to operatively control a traffic light apparatus mounted at a traffic intersection located at a geographic location having one or more neighboring/adjacent traffic intersections; a secondary traffic signal control system comprising one or more processors and a non-transitory memory coupled to the one or more processors, the non-transitory memory including a set of instructions, which when executed by the one or more processors, cause the one or more processors to perform operations including: training a machine learning (ML) model based on a training data set comprising traffic data to thereby obtain a trained ML model, capturing traffic sensor data at the one or more neighboring/adjacent traffic intersections, deploying the trained ML model to predict traffic flow at the traffic intersection based on the captured traffic sensor data, executing virtual emulation code to virtually emulate the traffic light apparatus and thereby obtain a virtually emulated traffic light apparatus, and autonomously controlling operation of the traffic light apparatus based on the predicted traffic flow by linking a primary traffic signal controller of the primary traffic signal control system to the virtually emulated traffic light apparatus.

In accordance with one example implementation, a traffic control management system comprises one or more of the following: a primary traffic signal control system to operatively control a traffic light apparatus mounted at a traffic intersection located at a geographic location having one or more neighboring/adjacent traffic intersections; a secondary traffic signal control system comprising one or more processors and a non-transitory memory coupled to the one or more processors, the non-transitory memory including a set of instructions, which when executed by the one or more processors, cause the one or more processors to perform operations including: training a first machine learning (ML) model based on a training data set comprising traffic data to thereby obtain a trained first ML model, training a second machine learning (ML) model based on the training data set to thereby obtain a trained second ML model, capturing traffic sensor data at the one or more neighboring/adjacent traffic intersections, deploying the trained first ML model to determine an optimum traffic signal state at the traffic intersection based on the captured traffic sensor data, deploying the trained second ML model to predict traffic flow at the traffic intersection based on the captured traffic sensor data, executing virtual emulation code to virtually emulate the traffic light apparatus and thereby obtain a virtually emulated traffic light apparatus, and autonomously controlling operation of the traffic light apparatus based on the predicted traffic flow and the determined optimum traffic signal state by linking a primary traffic signal controller of the primary traffic signal control system to the virtually emulated traffic light apparatus.

In accordance with each traffic control management system, autonomously controlling operation of the traffic light apparatus comprises preempting/isolating the primary traffic signal controller by linking the primary traffic signal controller to the virtually emulated traffic light apparatus.

In accordance with each traffic control management system, further comprising a sensor module operable to dynamically detect, as the traffic sensor data, vehicle traffic and objects at one or more neighboring/adjacent traffic intersections.

In accordance with each traffic control management system, the traffic sensor data comprises vehicle speed data and image data of vehicles, pedestrians, and objects at the one or more neighboring/adjacent traffic intersections.

In accordance with each traffic control management system, the secondary traffic signal control system is operable between a second operating state and a first operating state.

In accordance with each traffic control management system, in the second operating state the secondary traffic signal control system is operable to preempt the primary traffic signal controller from the traffic light apparatus.

In accordance with each traffic control management system, in the second operating state the secondary traffic signal control system is operable to cause the primary traffic signal control system to control the virtually emulated traffic light apparatus during the preemption.

In accordance with each traffic control management system, in the first operating state the secondary traffic signal control system cedes control of the traffic light apparatus to the primary traffic signal control system.

In accordance with each traffic control management system, the one or more neighboring/adjacent traffic intersections are adjacent or neighboring traffic intersections.

In accordance with one example implementation, a secondary traffic signal control system for a traffic control management system comprises one or more of the following: one or more processors and a non-transitory memory coupled to the one or more processors, the non-transitory memory including a set of instructions, which when executed by the one or more processors, cause the one or more processors to perform operations including: training a machine learning (ML) model based on a training data set comprising traffic data to thereby obtain a trained ML model, capturing traffic sensor data at one or more neighboring/adjacent traffic intersections located at a geographic location, deploying the trained ML model to determine an optimum traffic signal state at a traffic intersection among the one or more neighboring/adjacent traffic intersections based on the captured traffic sensor data, executing virtual emulation code to virtually emulate a traffic light apparatus at the traffic intersection and thereby obtain a virtually emulated traffic light apparatus, and autonomously controlling operation of the traffic light apparatus based on the determined optimum traffic signal state by linking a primary traffic signal controller of a primary traffic signal control system to the virtually emulated traffic light apparatus.

In accordance with one example implementation, a secondary traffic signal control system for a traffic control management system comprises one or more of the following: one or more processors and a non-transitory memory coupled to the one or more processors, the non-transitory memory including a set of instructions, which when executed by the one or more processors, cause the one or more processors to perform operations including: training a machine learning (ML) model based on a training data set comprising traffic data to thereby obtain a trained ML model, capturing traffic sensor data at the one or more neighboring/adjacent traffic intersections located at a geographic location, deploying the trained ML model to predict traffic flow at a traffic intersection among the one or more neighboring/adjacent traffic intersections based on the captured traffic sensor data, executing virtual emulation code to virtually emulate the traffic light apparatus and thereby obtain a virtually emulated traffic light apparatus, and autonomously controlling operation of the traffic light apparatus based on the predicted traffic flow by linking a primary traffic signal controller of a primary traffic signal control system to the virtually emulated traffic light apparatus.

In accordance with one example implementation, a secondary traffic signal control system for a traffic control management system comprises one or more of the following: one or more processors and a non-transitory memory coupled to the one or more processors, the non-transitory memory including a set of instructions, which when executed by the one or more processors, cause the one or more processors to perform operations including: training a first machine learning (ML) model based on a training data set comprising traffic data to thereby obtain a trained first ML model, training a second machine learning (ML) model based on the training data set to thereby obtain a trained second ML model, capturing traffic sensor data at one or more neighboring/adjacent traffic intersections located at a geographic location, deploying the trained first ML model to determine an optimum traffic signal state at a traffic intersection among the one or more neighboring/adjacent traffic intersections based on the captured traffic sensor data, deploying the trained second ML model to predict traffic flow at the traffic intersection based on the captured traffic sensor data, executing virtual emulation code to virtually emulate the traffic light apparatus and thereby obtain a virtually emulated traffic light apparatus, and autonomously controlling operation of the traffic light apparatus based on the predicted traffic flow and the determined optimum traffic signal state by linking a primary traffic signal controller of a primary traffic signal control system to the virtually emulated traffic light apparatus.

In accordance with each secondary traffic signal control system, autonomously controlling operation of the traffic light apparatus comprises preempting/isolating the primary traffic signal controller by linking the primary traffic signal controller to the virtually emulated traffic light apparatus.

In accordance with each secondary traffic signal control system, further comprising a sensor module operable to dynamically detect, as the traffic sensor data, vehicle traffic and objects at one or more neighboring/adjacent traffic intersections.

In accordance with each secondary traffic signal control system, the traffic sensor data comprises vehicle speed data and image data of vehicles, pedestrians, and objects at the one or more neighboring/adjacent traffic intersections.

In accordance with each secondary traffic signal control system, the secondary traffic signal control system is operable between a second operating state and a first operating state.

In accordance with each secondary traffic signal control system, in the second operating state the secondary traffic signal control system is operable to preempt the primary traffic signal controller from the traffic light apparatus.

In accordance with each secondary traffic signal control system, in the second operating state the secondary traffic signal control system is operable to cause the primary traffic signal control system to control the virtually emulated traffic light apparatus during the preemption.

In accordance with each secondary traffic signal control system, in the first operating state the secondary traffic signal control system cedes control of the traffic light apparatus to the primary traffic signal control system.

In accordance with each secondary traffic signal control system, the one or more neighboring/adjacent traffic intersections are adjacent or neighboring traffic intersections.

In accordance with one example implementation, a computer program product comprising at least one non-transitory computer readable medium having with a set of instructions of computer-executable program code, which when executed by one or more processors of an enterprise computer server system, cause the one or more processors to perform one or more of the following operations: training a machine learning (ML) model based on a training data set comprising traffic data to thereby obtain a trained ML model, capturing traffic sensor data at the one or more neighboring/adjacent traffic intersections, deploying the trained ML model to determine an optimum traffic signal state at the traffic intersection based on the captured traffic sensor data, executing virtual emulation code to virtually emulate the traffic light apparatus and thereby obtain a virtually emulated traffic light apparatus, and autonomously controlling operation of the traffic light apparatus based on the determined optimum traffic signal state by linking a primary traffic signal controller of the primary traffic signal control system to the virtually emulated traffic light apparatus.

In accordance with one example implementation, a computer program product comprising at least one non-transitory computer readable medium having with a set of instructions of computer-executable program code, which when executed by one or more processors of an enterprise computer server system, cause the one or more processors to perform one or more of the following operations: training a machine learning (ML) model based on a training data set comprising traffic data to thereby obtain a trained ML model, capturing traffic sensor data at the one or more neighboring/adjacent traffic intersections, deploying the trained ML model to predict traffic flow at the traffic intersection based on the captured traffic sensor data, executing virtual emulation code to virtually emulate the traffic light apparatus and thereby obtain a virtually emulated traffic light apparatus, and autonomously controlling operation of the traffic light apparatus based on the predicted traffic flow by linking a primary traffic signal controller of the primary traffic signal control system to the virtually emulated traffic light apparatus.

In accordance with one example implementation, a computer program product comprising at least one non-transitory computer readable medium having with a set of instructions of computer-executable program code, which when executed by one or more processors of an enterprise computer server system, cause the one or more processors to perform one or more of the following operations: training a first machine learning (ML) model based on a training data set comprising traffic data to thereby obtain a trained first ML model, training a second machine learning (ML) model based on the training data set to thereby obtain a trained second ML model, capturing traffic sensor data at the one or more neighboring/adjacent traffic intersections, deploying the trained first ML model to determine an optimum traffic signal state at the traffic intersection based on the captured traffic sensor data, deploying the trained second ML model to predict traffic flow at the traffic intersection based on the captured traffic sensor data, executing virtual emulation code to virtually emulate the traffic light apparatus and thereby obtain a virtually emulated traffic light apparatus, and autonomously controlling operation of the traffic light apparatus based on the predicted traffic flow and the determined optimum traffic signal state by linking a primary traffic signal controller of the primary traffic signal control system to the virtually emulated traffic light apparatus.

In accordance with each computer program product, autonomously controlling operation of the traffic light apparatus comprises preempting/isolating the primary traffic signal controller by linking the primary traffic signal controller to the virtually emulated traffic light apparatus.

In accordance with each computer program product, further comprising a sensor module operable to dynamically detect, as the traffic sensor data, vehicle traffic and objects at one or more neighboring/adjacent traffic intersections.

In accordance with each computer program product, the traffic sensor data comprises vehicle speed data and image data of vehicles, pedestrians, and objects at the one or more neighboring/adjacent traffic intersections.

In accordance with each computer program product, the secondary traffic signal control system is operable between a second operating state and a first operating state.

In accordance with each computer program product, in the second operating state the secondary traffic signal control system is operable to preempt the primary traffic signal controller from the traffic light apparatus.

In accordance with each computer program product, in the second operating state the secondary traffic signal control system is operable to cause the primary traffic signal control system to control the virtually emulated traffic light apparatus during the preemption.

In accordance with each computer program product, in the first operating state the secondary traffic signal control system cedes control of the traffic light apparatus to the primary traffic signal control system.

In accordance with each computer program product, the one or more neighboring/adjacent traffic intersections are adjacent or neighboring traffic intersections.

In accordance with one example implementation, a computer-implemented method for controlling a traffic signal traffic light apparatus comprises one or more of the following: training, by a secondary traffic signal control system, a machine learning (ML) model based on a training data set comprising traffic data to thereby obtain a trained ML model; capturing, by the secondary traffic signal control system, traffic sensor data at one or more neighboring/adjacent traffic intersections located at a geographic location; deploying, by the secondary traffic signal control system, the trained ML model to determine an optimum traffic signal state at a traffic intersection among the one or more neighboring/adjacent traffic intersections based on the captured traffic sensor data; executing, by the secondary traffic signal control system, virtual emulation code to virtually emulate a traffic light apparatus at the traffic intersection and thereby obtain a virtually emulated traffic light apparatus; and controlling, by the secondary traffic signal control system, the traffic light apparatus based on the determined optimum traffic signal state by linking a primary traffic signal controller of a primary traffic signal control system to the virtually emulated traffic light apparatus.

In accordance with one example implementation, a computer-implemented method for controlling a traffic signal traffic light apparatus comprises one or more of the following: training, by a secondary traffic signal control system, a machine learning (ML) model based on a training data set comprising traffic data to thereby obtain a trained ML model; capturing, by the secondary traffic signal control system, traffic sensor data at one or more neighboring/adjacent traffic intersections located at a geographic location; deploying, by the secondary traffic signal control system, the trained ML model to predict traffic flow at a traffic intersection among the one or more neighboring/adjacent traffic intersections based on the captured traffic sensor data; executing, by the secondary traffic signal control system, virtual emulation code to virtually emulate a traffic light apparatus at the traffic intersection and thereby obtain a virtually emulated traffic light apparatus; and controlling, by the secondary traffic signal control system, the traffic light apparatus based on the predicted traffic flow by linking a primary traffic signal controller of a primary traffic signal control system to the virtually emulated traffic light apparatus.

In accordance with one example implementation, a computer-implemented method for controlling a traffic signal traffic light apparatus comprises one or more of the following: training, by a secondary traffic signal control system, a first machine learning (ML) model based on a training data set comprising traffic data to thereby obtain a trained first ML model; training, by the secondary traffic signal control system, a second machine learning (ML) model based on the training data set to thereby obtain a trained second ML model; capturing, by the secondary traffic signal control system, traffic sensor data at one or more neighboring/adjacent traffic intersections located at a geographic location; deploying, by the secondary traffic signal control system, the trained first ML model to determine an optimum traffic signal state at a traffic intersection among the one or more neighboring/adjacent traffic intersections based on the captured traffic sensor data; deploying the trained second ML model to predict traffic flow at the traffic intersection based on the captured traffic sensor data; executing, by the secondary traffic signal control system, virtual emulation code to virtually emulate a traffic light apparatus at the traffic intersection and thereby obtain a virtually emulated traffic light apparatus; and controlling, by the secondary traffic signal control system, the traffic light apparatus based on the determined optimum traffic signal state and the predicted traffic flow by linking a primary traffic signal controller of a primary traffic signal control system to the virtually emulated traffic light apparatus.

In accordance with each computer-implemented method, autonomously controlling operation of the traffic light apparatus comprises preempting/isolating the primary traffic signal controller by linking the primary traffic signal controller to the virtually emulated traffic light apparatus.

In accordance with each computer-implemented method, further comprising a sensor module operable to dynamically detect, as the traffic sensor data, vehicle traffic and objects at one or more neighboring/adjacent traffic intersections.

In accordance with each computer-implemented method, the traffic sensor data comprises vehicle speed data and image data of vehicles, pedestrians, and objects at the one or more neighboring/adjacent traffic intersections.

In accordance with each computer-implemented method, the secondary traffic signal control system is operable between a second operating state and a first operating state.

In accordance with each computer-implemented method, in the second operating state the secondary traffic signal control system is operable to preempt the primary traffic signal controller from the traffic light apparatus.

In accordance with each computer-implemented method, in the second operating state the secondary traffic signal control system is operable to cause the primary traffic signal control system to control the virtually emulated traffic light apparatus during the preemption.

In accordance with each computer-implemented method, in the first operating state the secondary traffic signal control system cedes control of the traffic light apparatus to the primary traffic signal control system.

In accordance with each computer-implemented method, the one or more neighboring/adjacent traffic intersections are adjacent or neighboring traffic intersections.

### DRAWINGS

The various advantages of the exemplary embodiments will become apparent to one skilled in the art by reading the following specification and appended claims, and by referencing the following drawings, in which:

FIG. 1 illustrates an example implementation of a communication environment for a traffic control management system, in accordance with one or more embodiments set forth, illustrated, and described herein.

FIG. 2 illustrates a block diagram of a primary traffic signal control system for the traffic control management system of FIG. 1.

FIG. 3A illustrates a block diagram of a secondary traffic signal controller for the traffic control management system of FIG. 1.

FIG. 3B illustrates a block diagram of a secondary traffic signal server computer for the traffic control management system of FIG. 1.

FIG. 4 illustrates a block diagram of a sensor module for the traffic control management system of FIG. 1.

FIG. 5 illustrates another example implementation of a communication environment for a traffic control management system, in accordance with one or more embodiments set forth, illustrated, and described herein.

FIG. 6 illustrates the traffic control management system of FIG. 1 or FIG. 5 at a geographic location having one or more neighboring/adjacent traffic intersections, in accordance with one or more embodiments set forth and described herein.

FIGS. 7 through 9 respectively illustrate computer-implemented methods for controlling a traffic signal, in accordance with one or more embodiments set forth and described herein.

### DESCRIPTION

The present disclosure relates to a traffic control management system, a traffic signal control system for such a traffic control management system, a computer program product, and one or more computer-implemented methods for controlling a traffic light apparatus mounted at a traffic intersection located at a geographic location having one or more neighboring/adjacent traffic intersections.

The traffic control management system includes a primary traffic signal control system operable to serve as a primary controller of a traffic light apparatus mounted at a traffic intersection located at a geographic location having one or more neighboring/adjacent traffic intersections and a secondary traffic signal control system operable to serve as a secondary controller of the traffic light apparatus, a sensor module, and a communication network. In accordance with each example implementation, a hierarchical control scheme is established in which there is no simultaneous control of the traffic light apparatus by the primary traffic signal control system and the secondary traffic signal control system. The primary traffic signal control system is operable to establish primary control of the traffic light apparatus, whereas the secondary traffic signal control system is operable to establish secondary control of the traffic light apparatus under one or more detected conditions. For example, when the primary traffic signal control system is in control of the traffic light apparatus, the secondary traffic signal control system will not have control of the traffic light apparatus. On the other hand, when the secondary traffic signal control system is in control of the traffic light apparatus, the primary traffic signal control system will cede control of the traffic light apparatus and be linked to a virtually emulated traffic light apparatus.

The secondary traffic signal control system includes a secondary traffic signal controller and a secondary traffic signal server computer. The secondary traffic signal control system is operable to dynamically transform traffic data in a manner that imparts several advantages, including, but not limited to reducing overall travel time, reducing start/stops/delays, prioritizing traffic lights for emergency services and/or transit vehicles, reducing emissions, enhancing pedestrian safety, and reducing unsafe traffic intersection actions (dilemma zone yellow lights).

The secondary traffic signal server computer has one or more high performance host processors, and one or more graphics processers operable to perform or conduct tensor math with large AI models. The secondary traffic signal server computer has a plurality of primary tasks including, but not limited to capturing traffic data from one or more neighboring/adjacent traffic intersections, disseminating and distributing the captured traffic data to neighboring/adjacent intersections, and transforming the captured traffic data for use in an AI/ML model to determine an optimum traffic signal state at a traffic intersection and/or predict traffic flow at the traffic intersection.

The secondary traffic signal server computer may additionally be operable to dynamically perform one or more additional operations: object detection, multi-object tracking, object/vehicle distance, speed, and direction estimation, emergency vehicle detection, detection of impending collisions/near misses of Vehicle-Vehicle (V2V) and Vehicle-VRU (Vulnerable Road User, i.e., pedestrian, cyclist, etc.). The secondary traffic signal server computer may report the following data and information to neighboring/adjacent intersections: vehicle and pedestrian travel times/wait times (e.g., delays), average vehicle speeds, timestamp of vehicle exit times through a traffic intersection, vehicle identification (e.g., vehicle license plate numbers), the operating state of a traffic intersection, including vehicle counts in all directions, vehicle and pedestrian positions, and hardware telemetry of all devices capable of being monitored. The secondary traffic signal server computer is operable for fully remote updating, thereby receiving updated and/or new algorithms and enhancements. This allows enhanced control of a traffic signal apparatus in a manner that reduces municipal/governmental intervention.

The secondary traffic signal controller may operate between a first operating state and a second operating state. In the first operating state, the secondary traffic signal controller is operable to cede operational control of the traffic light apparatus to the primary traffic signal control system. In the second operating state, the secondary traffic signal controller is operable to autonomously control operation of the traffic light apparatus, at least on a temporary basis based on one or more detected traffic conditions For example, the secondary traffic signal controller may cede autonomously control to the primary traffic signal controller once the one or more detected traffic conditions no longer exist. Alternatively or additionally, the secondary traffic signal controller is operable to autonomously control operation of the traffic light apparatus in response to a detection of a malfunction operating state of the primary traffic signal controller.

The secondary traffic signal controller is operable to be programmed with critical traffic safety data and information including, but not limited to minimum clearances for each traffic light phase, channel compatibility, pedestrian channels and timers, overlaps, flashing yellow arrow (FYA) modes, and any other critical traffic safety data and information. The secondary traffic signal controller has operational protocols that prevent it from being reprogrammed remotely or while the traffic intersection is in operation. The secondary traffic signal controller is operable to accepts requests or commands to autonomously control operation of the traffic light apparatus and change the traffic lights of the traffic light apparatus. In the transition from the second operating state and the first operating state, the secondary traffic signal controller adheres to all safety timers while changing the lights. As the secondary traffic signal server computer issues a command to change the traffic lights, the secondary traffic signal controller monitors each transition for safety violations, disallowing any request determined to be unsafe or in violation of a traffic rule. The traffic control scheme ensures traffic safety, even should the secondary traffic signal control system be compromised by an unauthorized breach.

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint™, Excel™) and cloud applications which may reside in the cloud (e.g., Gmail™, GitHub™). Cloud applications may correspond to applications on the client device or may be other types such as social media applications (e.g., Facebook™).

As used herein, “artificial intelligence (AI)” relates to one or more computer system operable to perform one or more tasks that normally require human intelligence, such as visual perception, speech recognition, decision-making, and translation between languages.

As used herein, “camera” relates to any device, component, and/or system that can capture visual image data. Such visual image data may include one or more of video data and image data. The visual image data may be in any suitable form.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” or “mobile device” relates to any device associated with a user, including personal computers, laptops, tablets, and/or mobile smartphones.

As used herein, “geofence” relates to a virtual perimeter or boundary around a geographic location.

As used herein, “geographic location” relates to a physical place or point on a surface of the earth that is represented by latitude and longitude coordinates.

As used herein, “lidar sensor” relates to any device, component and/or system that can detect, determine, assess, monitor, measure, quantify, and/or sense something using at least in part lasers.

As used herein, “machine learning” relates to an application of AI that provides computer systems the ability to automatically learn and improve from data and experience without being explicitly programmed.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “radar sensor” relates to any device, component and/or system that can detect, determine, assess, monitor, measure, quantify, and/or sense something using, at least in part, radio signals.

As used herein, “real-time” relates to a level of processing responsiveness that a user, module, or system senses as sufficiently immediate for a particular process or determination to be made, or that enables the processor to keep up with some external process.

As used herein, “target location” or a “point-of-interest (POI) location” relates to a specific location on the surface of the earth that is a candidate location to host an event to be scheduled (i.e., the event to occur at a future date).

As used herein, “user” relates to a consumer, machine entity, and/or requesting party, and may be human or machine.

As used herein, “virtual emulation code” relates to a computing environment configured in a first architecture to emulate a second architecture (different from the first architecture), and to execute software and instructions developed based on the second architecture.

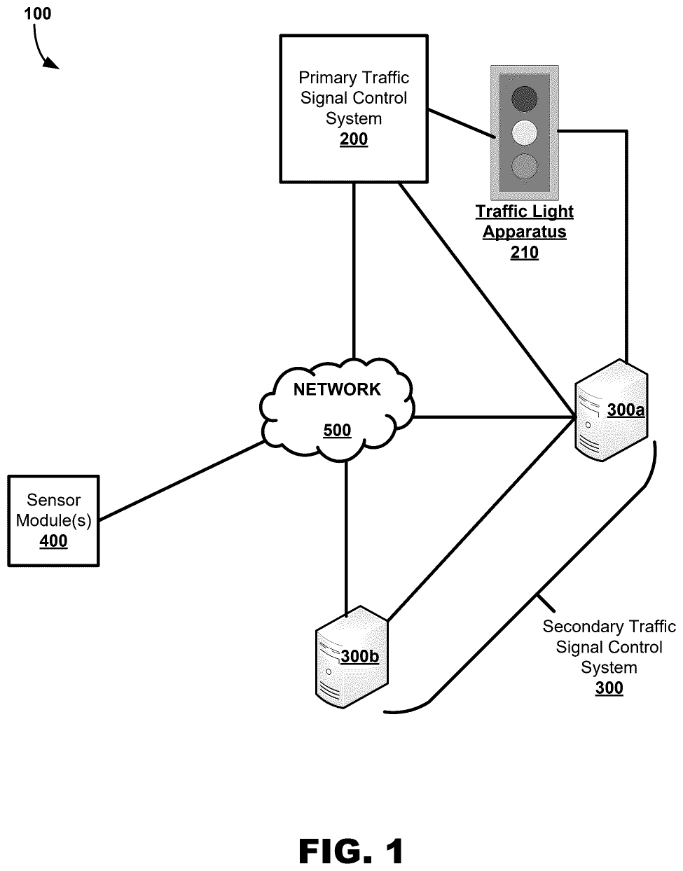

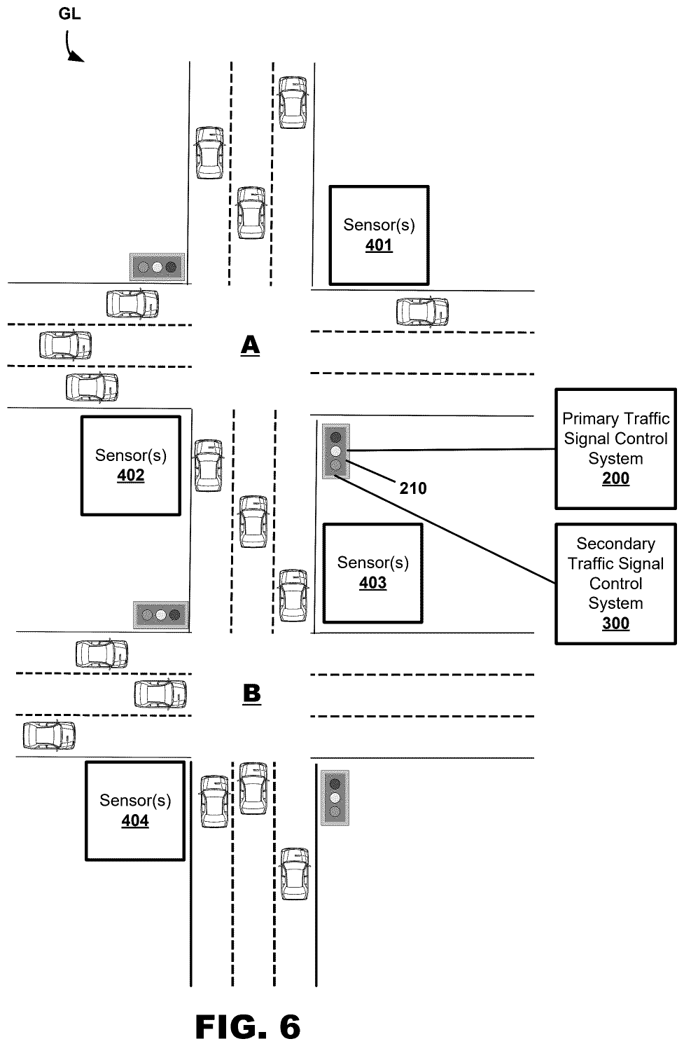

Turning to the figures, in which FIG. 1 illustrates a communication environment for a traffic control management system 100. The traffic control management system 100 comprises a primary traffic signal control system 200 operable to serve as a primary controller of a traffic light apparatus 210 mounted at a traffic intersection located at a geographic location GL having one or more neighboring/adjacent traffic intersections A, B (FIG. 6), a secondary traffic signal control system 300 operable to serve as a secondary controller of the traffic light apparatus 210, a sensor module 400, and a communication network 500 through which communication is facilitated between the primary traffic signal control system 200, the secondary traffic signal control system 300, and the sensor module 400.

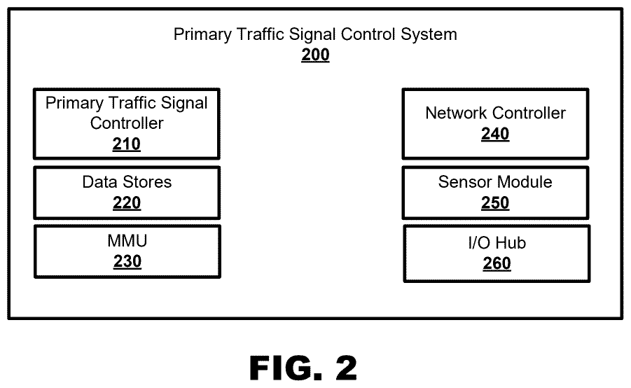

In the illustrated example embodiment of FIG. 2, the primary traffic signal control system 200 comprises a primary traffic signal controller 210, one or more data stores 220, a malfunction management unit (MMU) 230, a network controller 240, a sensor module 250, and an I/O hub 260. The illustrated example embodiment includes some of the possible operational elements of the primary traffic signal controller 210 and will now be described herein. It will be understood that it is not necessary for the primary traffic signal control system 200 to have all the elements illustrated in FIG. 2. For example, the primary traffic signal control system 200 may have any combination of the various elements illustrated in FIG. 2. Moreover, the primary traffic signal control system 200 may have additional elements to those illustrated in FIG. 2.

The primary traffic signal controller 210 comprises a computing device, including, but not limited to a desktop computer, a laptop computer, a smart phone, a handheld personal computer, a workstation, a game console, a cellular phone, a client device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the primary traffic signal controller 210 comprising any form of electronic device that optimizes or otherwise transforms the performance and functionality of the one or more embodiments in a manner that falls within the spirit and scope of the principles of this disclosure.

The secondary traffic signal control system 300 comprises a secondary traffic signal controller 300a and a secondary traffic signal server computer 300b. The secondary traffic signal controller 300a and the secondary traffic signal server computer 300b may be used in any combination, and may be used redundantly to validate and improve the accuracy of the detection. This disclosure contemplates the structural hardware, the software, and functionality of the secondary traffic signal controller 300a and the secondary traffic signal server computer 300b being consolidated for performance by a single, unitary computing device.

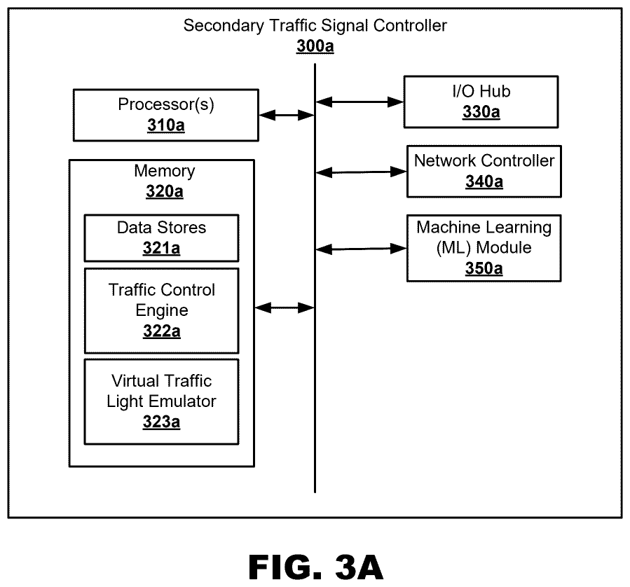

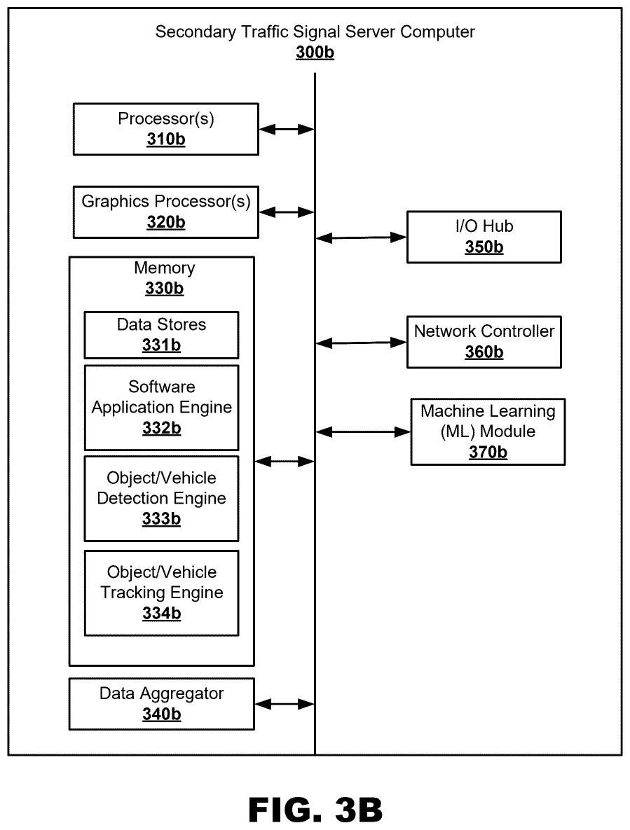

In the illustrated example embodiment of FIG. 3A, the secondary traffic signal controller 300a comprises a computing device, including, but not limited to a desktop computer, a laptop computer, a smart phone, a handheld personal computer, a workstation, a game console, a cellular phone, a client device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the secondary traffic signal controller 300a comprising any form of electronic device that optimizes or otherwise transforms the performance and functionality of the one or more embodiments in a manner that falls within the spirit and scope of the principles of this disclosure.

The secondary traffic signal controller 300a includes one or more processors 310a, a non-transitory memory 320a operatively coupled to the one or more processors 310a, an I/O hub 330a, a network controller 340a, and a machine learning (ML) module 350a.

The one or more processors 310a include logic (e.g., logic instructions, configurable logic, fixed-functionality hardware logic, etc., or any combination thereof) to perform one or more aspects of the computer-implemented methods 600, 700, 800, and 900 set forth, illustrated, and described herein.

The non-transitory memory 320a comprises a set of instructions of computer-executable program code. The set of instructions are executable by the one or more processors 310a to cause execution of an operating system and one or more software applications of a software application module that reside in the non-transitory memory 320a. The one or more software applications residing in the non-transitory memory 320a includes, but is not limited to, one or more enterprise applications associated with an enterprise. Residing in the non-transitory memory 320a are a traffic control engine 322a and a virtual traffic light emulator 323a. Each enterprise application comprises a mobile application or desktop application that facilitates establishment of a secure connection between the secondary traffic signal controller 300a and the primary traffic signal control system 200. The one or more processors 310a are operable to execute the mobile application or desktop application.

The non-transitory memory 320a also includes one or more data stores 321a that are operable to store one or more types of data. The secondary traffic signal controller 300a may include one or more interfaces that facilitate one or more systems or modules thereof to transform, manage, retrieve, modify, add, or delete, the data residing in the data stores 321a. The one or more data stores 321a may comprise volatile and/or non-volatile memory. Examples of suitable data stores 321a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 321a may be a component of the one or more processors 310a or alternatively, may be operatively connected to the one or more processors 310a for use thereby. As set forth, described, and/or illustrated herein, “operatively connected” may include direct or indirect connections, including connections without direct physical contact.

The I/O hub 330a is operatively connected to other systems and subsystems of the secondary traffic signal controller 300a. The I/O hub 330a may include one or more of an input interface, an output interface, and a network controller to facilitate communications between the secondary traffic signal controller 300a, the primary traffic signal control system 200, and the sensor module 400. The input interface and the output interface may be integrated as a single, unitary user interface, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 310a to execute instructions. The input interface may comprise a user interface (UI), a graphical user interface (GUI), such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the enterprise client device 100 may serve as both a component of the input interface and a component of the output interface.

The network controller 340a operable to facilitate connection to the network 300. The network controller 340a can comprise an Ethernet adapter or another wired network adapter. The network controller 340a can include one or more of a Wi-Fi, Bluetooth, near field communication (NFC), or other network device that includes one or more wireless radios. In one or more example embodiments, the secondary traffic signal controller 300a may communicate, via the network controller 340a, with a wireless PAN (WPAN) (such as, for example, a BLUETOOTH WPAN), a WI-FI network, a WI-MAX network, a cellular telephone network (such as, for example, a Global System for Mobile Communications (GSM) network), or a combination thereof. Embodiments, however, are not limited thereto, and thus, this disclosure contemplates any suitable other suitable wireless network architecture that permits practice of the one or more embodiments.

The ML module 350a may comprise one or more processors, and one or more data stores (e.g., non-volatile memory/NVM and/or volatile memory) containing a set of instructions, which when executed by the one or more processors, cause the ML module 350a to capture traffic data from the primary traffic signal control system 200, the one or more processors 310a, the non-transitory memory 320a, the sensor module 400, any third-party database(s), and any other input/output sources, and process the captured data to, inter alia, train one or more ML models based on the captured data and information.

The ML module 350a may include one or more ML algorithms to train one or more machine learning models based on training data that may include previously captured traffic data. The ML algorithms may include one or more of a linear regression algorithm, a logical regression algorithm, or a combination of different algorithms. A neural network may also be used to train the system based on captured data including, but not limited to, traffic data, geographic location data, sensor data, traffic data derived from third-party databases, etc. In one or more example embodiments, such a neural network may include, but is not limited to, a YOLO neural network. The ML module 350a may analyze the captured traffic data and/or information, and transform the captured traffic data and/or information in a manner which provides enhanced communication between the traffic control management system 100 and the secondary traffic signal control system 300.

Examples of ML models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a ML model (or other type of AI-based learning models) may include supervised learning (e.g., based on labelled input data), unsupervised learning, and reinforcement learning. In various embodiments, a ML model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

The traffic data and information may be captured based on predefined preferences. The captured traffic data and information may also be up-linked to other systems, subsystems, and modules in the secondary traffic signal control system 300 for further processing to discover additional information that may be used to enhance the understanding of the data and information. The ML module 350a may also transmit information to other client devices, and link to other electronic devices, including but not limited to smart phones, smart home systems, or Internet-of-Things (IoT) devices. The ML module 350a may thereby communicate with/to other client devices, systems, users, etc.

In the illustrated example embodiment of FIG. 3B, the secondary traffic signal server computer 300b comprises one or more server computers. The secondary traffic signal server computer 300b includes one or more host processors 310b, one or more graphics processors 320b, a non-transitory memory 330b operatively coupled to the one or more host processors 310b and the one or more graphics processors 320b, a data aggregator 340b, an I/O hub 350b, a network controller 360b, and a machine learning (ML) module 370b. Some of the possible operational elements of each server in the secondary traffic signal server computer 300b are illustrated in FIG. 3B and will now be described herein. It will be understood that it is not necessary for each server in the secondary traffic signal server computer 300b to have all the elements illustrated in FIG. 3B. For example, each server in the secondary traffic signal server computer 300b may have any combination of the various elements illustrated in FIG. 3B. Moreover, each server in the secondary traffic signal server computer 300b may have additional elements to those illustrated in FIG. 3B.

The secondary traffic signal server computer 300b may be controlled by a system manager (or policy manager) of the enterprise.

In accordance with one or more embodiments set forth, described, and/or illustrated herein, the secondary traffic signal server computer 300b may comprise one or more computing devices, each computing device including but not limited to a server computer, a desktop computer, a laptop computer, a smart phone, a handheld personal computer, a workstation, a game console, a cellular phone, a client device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the secondary traffic signal server computer 300b comprising any form of electronic device that optimizes or otherwise transforms the performance and functionality of the one or more embodiments in a manner that falls within the spirit and scope of the principles of this disclosure.

The one or more graphics processors 320b include logic (e.g., logic instructions, configurable logic, fixed-functionality hardware logic, etc., or any combination thereof) to perform calculations and/or one or more aspects of the computer-implemented methods 600, 700, 800, and 900 set forth, illustrated, and described herein.

The non-transitory memory 330b comprises a set of instructions of computer-executable program code. The set of instructions are executable by the one or more host processors 310b in manner that facilitates control of a software application engine 332b having one or more enterprise applications that reside in the non-transitory memory 330b, an object/vehicle detection engine 333b, and an object/vehicle tracking engine 334b. In accordance with one or more embodiments set forth, described, and/or illustrated herein, the secondary traffic signal server computer 300b may individually or collectively execute the instructions to perform any one or more of the methodologies set forth, described, and illustrated herein.

The object/vehicle detection engine 333b may be implemented as computer readable program code that, when executed by the one or more host processors 310b, implement one or more of the various processes set forth, described, and/or illustrated herein, including, for example, to detect objects/vehicles in the ambient environment that are in the geographic location GL having the one or more neighboring/adjacent traffic intersections A, B. The object/vehicle detection engine 333b may include a set of logic instructions executable by the one or more host processors 310b. Alternatively or additionally, the one or more data stores 331b may contain such logic instructions. The logic instructions may include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.). The detection of objects/vehicles may be performed in any suitable manner. For instance, the detection may be performed using traffic data captured by the sensor module 400.

The object/vehicle tracking engine 334b may be implemented as computer readable program code that, when executed by the one or more host processors 310b, implements one or more of the various processes set forth, described, and/or illustrated herein, including, to one or more of follow, observe, watch, and track the movement of objects/vehicles over a plurality of sensor observations. As set forth, described, and/or illustrated herein, “sensor observation” relates to a moment of time or a period of time in which one or more sensors 410-404 of the sensor module 440 are used to capture traffic data. The object/vehicle tracking engine 334b may comprise logic instructions executable by one or more host processors 310b. Alternatively or additionally, the one or more data stores 331b may contain such logic instructions. The logic instructions may include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.). The object/vehicle tracking engine 334b may be operable cause the dynamic tracking of detected objects/vehicles that are in the geographic location GL. Such tracking of detected objects/vehicles may occur over a plurality of sensor detection moments or frames.

The non-transitory memory 330b also includes one or more data stores 331b that are operable to store one or more types of data, including but not limited to, input setting data, profile data, user account data, user authentication data, sensor data, etc. For instance, the one or more data stores 331b may comprise a storage location on which one or more electronic files reside. The one or more data stores 331b may comprise volatile and/or non-volatile memory. Examples of suitable data stores 331b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable non-transitory storage medium, or any combination thereof. The one or more data stores 331b may be a component of the one or more host processors 310b, or alternatively, may be operatively connected to the one or more host processors 310b for use thereby. As set forth, described, and/or illustrated herein, “operatively connected” may include direct or indirect connections, including connections without direct physical contact.

The non-transitory memory 330b may include a single machine-readable medium, or a plurality of media (e.g., a centralized or distributed database, or associated caches and servers) operable to store the instructions. The term “machine-readable medium” shall also be taken to include any medium, or combination of multiple media, that is capable of storing instructions (e.g., software) for execution by a server computer (e.g., server), such that the instructions, when executed by the one or more host processors 310b, cause the secondary traffic signal server computer 300b to perform any one or more of the methodologies set forth, described, and illustrated herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The computer-executable program code may instruct the one or more host processors 310b to execute certain logic, data-processing, and data-storing functions of the secondary traffic signal server computer 300b, in addition to certain communication functions of the secondary traffic signal server computer 300b. The one or more enterprise applications of the software application engine 332b are operable to communicate with the secondary traffic signal server computer 300b in a manner which facilitates user access to traffic data, systems, and sub-systems of the secondary traffic signal server computer 300b based on successful user authentication.

The data aggregator 340b is operable to capture, receive, collect, or otherwise acquire traffic data from sources that include the sensors 401-404 of the sensor module 400, and third-party party databases, format the traffic data for distribution to one or more of the secondary traffic signal controller 300a, the one or more host processors 310b, the one or more graphics processors 320b, the object/vehicle detection engine 333b, the object/vehicle tracking engine 334b, and the ML module 370b.

The ML module 370b may comprise one or more processors, and one or more data stores (e.g., non-volatile memory/NVM and/or volatile memory) containing a set of instructions, which when executed by the one or more host processors 310b and/or the one or more graphics processors 320b, cause the ML module 370b to capture data from the secondary traffic signal controller 300a, the non-transitory memory 330b, the data aggregator 340b, the sensor module 400, third-party database(s), and any other input/output sources, and process the captured data to, inter alia, train one or more ML models based on the captured data. The captured traffic data may be stored in the non-transitory memory 330b to update one or more of the training data sets.

The ML module 370b may include one or more ML algorithms to train one or more machine learning models of the secondary traffic signal server computer 300b based on the captured data. The ML algorithms may include one or more of a linear regression algorithm, a logical regression algorithm, or a combination of different algorithms. A neural network may also be used to train the system based on captured data, including, but not limited to, authentication data, geographic locationdata, sensor data, profile data, etc. In one or more example embodiments, such a neural network may include, but is not limited to, a YOLO neural network. The ML module 370b may analyze the captured data, and transform the captured data in a manner which provides enhanced communication between the primary traffic signal control system 200 and the secondary traffic signal control system 300.

Data and information may be captured based on predefined preferences. The captured data and information may also be up-linked to other systems and modules in the secondary traffic signal control system 300 for further processing to discover additional information that may be used to enhance the understanding of the data and information. The ML module 370b may also transmit information to other client devices, and link to other electronic devices, including but not limited to smart phones, smart home systems, or Internet-of-Things (IoT) devices. The ML module 370b may thereby communicate with/to other devices, systems, users, etc.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

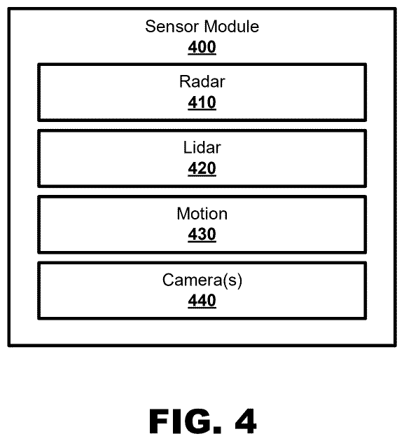

In the illustrated example embodiment of FIG. 4, the sensor module 400 is operable to dynamically detect, determine, assess, monitor, measure, quantify, and/or sense information in the geographic location GL having the one or more neighboring/adjacent traffic intersections A, B. As set forth, described, and/or illustrated herein, “sensor” means any device, component and/or system that can perform one or more of detecting, determining, assessing, monitoring, measuring, quantifying, and sensing something. The one or more sensors may be configured to detect, determine, assess, monitor, measure, quantify and/or sense in real-time. As set forth, described, and/or illustrated herein, “real-time” means a level of processing responsiveness that a user or system senses as sufficiently immediate for a particular process or determination to be made, or that enables the processor to keep up with some external process.

The sensor module 400 may comprise for example, one or more sensors 401-404 operable to detect, determine, assess, monitor, measure, quantify, and/or sense objects, vehicles, road infrastructure elements, etc. in the geographic location GL. The one or more sensors 401-404 may include, but not limited to ranging sensors (e.g., light detection and ranging, radio detection and ranging/radar, sound navigation and ranging/sonar), depth sensors, and image sensors (e.g., red, green, blue/RGB camera, multi-spectral infrared/IR camera). In particular, the one or more sensors 401-404 may comprise radar sensors 410, lidar sensors 420, motion sensors 430, and cameras 440. It will be understood that the embodiments are not limited to the particular sensors described herein.

The one or more sensors 401-404 may be configured to detect, determine, assess, monitor, measure, quantify, and/or sense information in the geographic location GL including, but not limited to information about objects, vehicles, road infrastructure elements, etc. in the ambient environment. Such objects may include, but is not limited to objects that are spatially on, above, and/or over the roadway path, e.g., animals, tires, debris, rocks, and pedestrians. Such road infrastructure elements may include, but is not limited to fixed, physical assets, the roadway surface, signage, drainage, bridges, parking curbs, etc. In one or more example embodiments, detection of objects and road infrastructure elements in the ambient environment may come from one or more You Only Look Once (YOLO) detectors or one or more Single Shot Detectors (SSD).

The sensor module 400 and/or the one or more sensors 401-404 may be operatively connected to the secondary traffic signal controller 300a, the secondary traffic signal server computer 300b and/or other elements, components, systems, subsystems, and modules of the traffic control management system 100. The sensor module 400 and/or the one or more sensors 401-404 set forth, illustrated, and described herein may be provided or otherwise positioned in any suitable location in the geographic location GL.

In accordance with one or more embodiments, the one or more sensors 401-404 may work independently from each other, or alternatively, may work in combination with each other. The sensors 401-404 may be used in any combination, and may be used redundantly to validate and improve the accuracy of the detection.

The one or more radar sensors 410 may be configured to detect, determine, assess, monitor, measure, quantify, and/or sense, directly or indirectly, the presence of objects, vehicles, road infrastructure elements, etc. in the geographic location GL, the relative position of each detected object, vehicle, road infrastructure element, etc. relative to the traffic intersection where the traffic light apparatus 210 is mounted, the spatial distance between the traffic intersection and each detected object, vehicle, road infrastructure element, etc. in one or more directions (e.g., in a longitudinal direction, a lateral direction, and/or other direction(s)), the spatial distance between each detected object, vehicle, road infrastructure element, etc. and other detected objects, vehicles, road infrastructure elements, etc. in one or more directions (e.g., in a longitudinal direction, a lateral direction, and/or other direction(s)), a current speed of each detected object, vehicle, road infrastructure element, etc. and/or the movement of each detected object, vehicle, road infrastructure element.

The one or more lidar sensors 420 may comprise a laser source and/or laser scanner configured to transmit a laser and a detector configured to detect reflections of the laser. The one or more lidar sensors 420 may be configured to operate in a coherent or an incoherent detection mode. The one or more lidar sensors 420 may comprise high resolution lidar sensors. The one or more lidar sensors 420 may be configured to detect, determine, assess, monitor, measure, quantify and/or sense, directly or indirectly, the presence of objects, vehicles, road infrastructure elements, etc. in the geographic location GL, the position of each detected object, vehicle, road infrastructure element, etc. relative to the traffic intersection where the traffic light apparatus 210 is mounted, the spatial distance between the traffic intersection and each detected object, vehicle, road infrastructure element, etc. in one or more directions (e.g., in a longitudinal direction, a lateral direction and/or other direction(s)), the elevation of each detected object and road infrastructure element, the spatial distance between each detected object, vehicle, road infrastructure element, etc. and other detected objects, vehicles, road infrastructure elements, etc. in one or more directions (e.g., in a longitudinal direction, a lateral direction, and/or other direction(s)), the current speed of each detected object, vehicle, road infrastructure element, etc., and/or the movement of each detected object, vehicle, road infrastructure element, etc.

The one or more cameras 440 may comprise high resolution cameras. The high resolution can refer to the pixel resolution, the spatial resolution, spectral resolution, temporal resolution, and/or radiometric resolution. The one or more cameras 440 may comprise high dynamic range (HDR) cameras or infrared (IR) cameras. One or more of the cameras 440 may comprise a lens and an image capture element. The image capture element may be any suitable type of image capturing device or system, including, for example, an area array sensor, a charge coupled device (CCD) sensor, a complementary metal oxide semiconductor (CMOS) sensor, a linear array sensor, and/or a CCD (monochrome). The image capture element may capture images in any suitable wavelength on the electromagnetic spectrum. The image capture element may capture color images and/or grayscale images. The one or more of the cameras 440 may be configured with zoom in and/or zoom out capabilities. The one or more cameras 440 may be spatially oriented, positioned, configured, operable, and/or arranged to capture visual image data from at least a portion of the ambient environment at the geographic location GL. The one or more cameras 440 may be fixed in a position that does not change relative to the geographic location GL. Alternatively or additionally, one or more of the cameras 440 may be movable to change its position relative to the geographic location GL in a manner which facilitates the capture of visual image data from different portions of the ambient environment. Such movement of the one or more cameras 440 may be achieved in any suitable manner, such as, for example, by rotation (about one or more rotational axes), by pivoting (about a pivot axis), by sliding (along an axis), and/or by extending (along an axis).

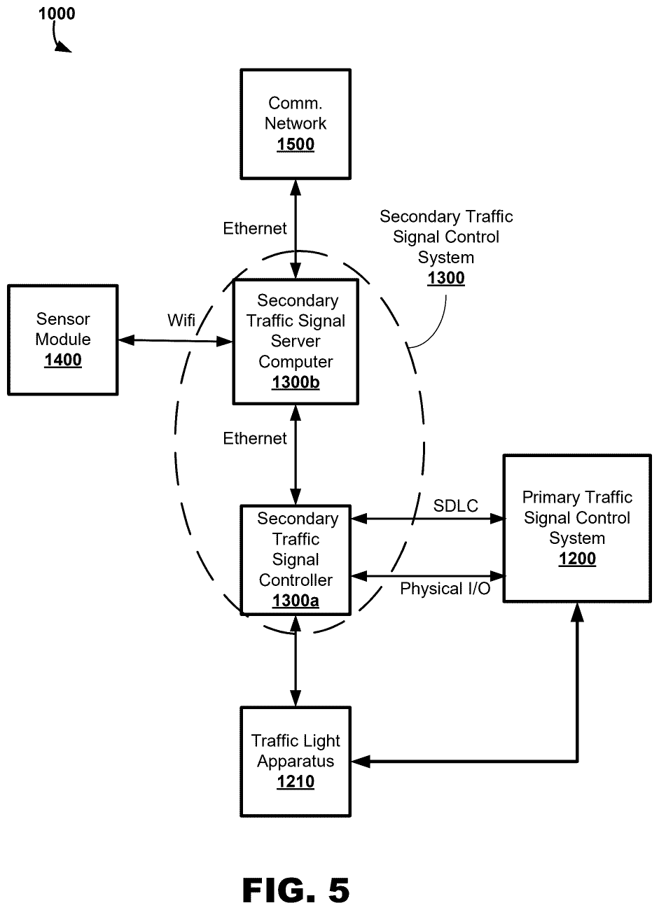

The illustrated example of FIG. 5 provides another example implementation of a communication environment for a traffic signal control system 1000. The traffic signal control system 1000 comprises a primary traffic signal control system 1200 operable to serve as a primary controller of a traffic light apparatus 1210 mounted at a traffic intersection located at a geographic location GL having one or more neighboring/adjacent traffic intersections A, B (see FIG. 6), a secondary traffic signal control system 1300 operable to serve as a secondary controller of the traffic light apparatus 1210, a sensor module 1400 having one or more sensors 1401-1404, and a communication network 1500 through which communication is facilitated between the primary traffic signal control system 1200, the secondary traffic signal control system 1300, and the sensor module 1400. The operational connection between the components may be wired, wireless, or a combination thereof.

In accordance with one or more example implementations, the secondary traffic signal server computer 300b is operable to perform at least one or more of the following operations: (i) train, via the ML module 370b, a machine learning (ML) model based on a training data set comprising traffic data to thereby obtain a trained ML model, (ii) capture, via object/vehicle detection engine 333b and/or object/vehicle tracking engine 334b, traffic sensor data at the one or more neighboring/adjacent traffic intersections, (iii) deploy one or more trained ML models to determine an optimum traffic signal state and/or predict traffic flow at the traffic intersection based on the captured traffic sensor data; (iv) distribute data and information relating to the optimum traffic signal state determination and/or the traffic flow prediction to the secondary traffic signal controller 300a; and (v) distribute traffic data to primary traffic signal controllers at neighboring/adjacent traffic intersections.

In accordance with one or more example implementations, the secondary traffic signal controller 300a is operable between a second operating state and a first operating state. In the first operating state, the secondary traffic signal controller 300a is operable to cede control of the traffic light apparatus 210 to the primary traffic signal control system 200.

In response to the optimum traffic signal state determination and/or the traffic flow prediction, the secondary traffic signal controller 300a may operate in the second operating state to perform one or more of the following operations: (i) execute virtual emulation code to virtually emulate the traffic light apparatus and thereby obtain a virtually emulated traffic light apparatus, (ii.) preempt/isolate the primary traffic signal control system 200 from the traffic light apparatus 210, (iii) cause the primary traffic signal controller 210 to control a virtual emulated traffic light apparatus, and (iv) autonomously control operation of the traffic light apparatus based on the determined optimum traffic signal state by linking a primary traffic signal controller of the primary traffic signal control system to the virtually emulated traffic light apparatus.

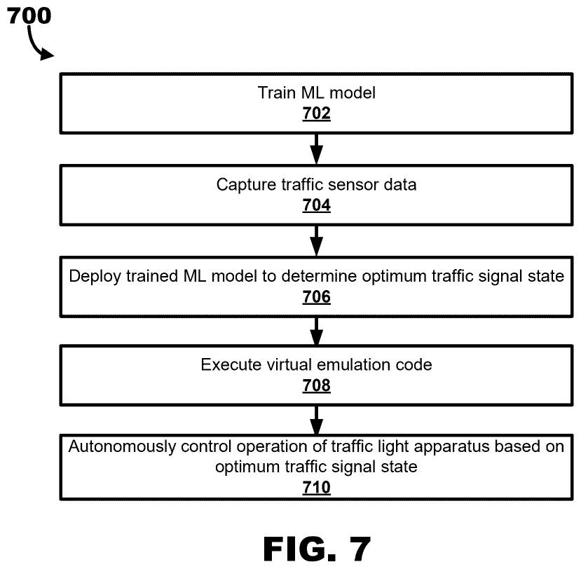

Illustrated examples shown in FIGS. 7 to 9 set forth computer-implemented methods 700, 800, and 900 for controlling a traffic light apparatus mounted at a traffic intersection located at a geographic location having one or more neighboring/adjacent traffic intersections. In one or more examples, the respective flowcharts of the computer-implemented methods 700, 800, and 900 may be implemented by the one or more processors 310a of the secondary traffic signal controller 300a and/or the one or more processors 310b of the secondary traffic signal server computer 300b. In particular, the computer-implemented methods 700, 800, and 900 may be implemented as one or more modules in a set of logic instructions stored in a non-transitory machine or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the enterprise server computing system 200 provides functionality described or illustrated herein. In particular, software executed by the one or more processors 310a of the secondary traffic signal controller 300a and/or the one or more processors 310b of the secondary traffic signal server computer 300b is operable to perform one or more processing blocks of the computer-implemented methods 700, 800, and 900 set forth, described, and/or illustrated herein, or provides functionality set forth, described, and/or illustrated.

As illustrated in FIG. 7, illustrated process block 702 includes training, by a secondary traffic signal control system (e.g., secondary traffic signal control system 300) a machine learning (ML) model based on a training data set comprising traffic data to thereby obtain a trained ML model.

The computer-implemented method 700 may then proceed to illustrated process block 704, which includes capturing, by the secondary traffic signal control system, traffic sensor data at the one or more neighboring/adjacent traffic intersections (e.g., adjacent traffic intersections) located at a geographic location.

In accordance with illustrated process block 704, the traffic sensor data comprises vehicle speed data.

In accordance with illustrated process block 704, the traffic sensor data comprises image data of vehicles, pedestrians, and objects at the one or more neighboring/adjacent traffic intersections.

In accordance with illustrated process block 704, the traffic sensor data comprises vehicle identification data (e.g., vehicle license plate numbers).

The computer-implemented method 700 may then proceed to illustrated process block 706, which includes deploying, by the secondary traffic signal control system, the trained ML model to determine an optimum traffic signal state at the traffic intersection based on the captured traffic sensor data.

The computer-implemented method 700 may then proceed to illustrated process block 708, which includes executing, by the secondary traffic signal control system, virtual emulation code to virtually emulate the traffic light apparatus and thereby obtain a virtually emulated traffic light apparatus.

The computer-implemented method 700 may then proceed to illustrated process block 710, which includes controlling, by the secondary traffic signal control system, the traffic light apparatus based on the determined optimum traffic signal state.

In accordance with illustrated process block 710, autonomously controlling operation of the traffic light apparatus comprises linking a primary traffic signal controller (e.g., primary traffic signal controller 210) of a primary traffic signal control system (e.g., primary traffic signal control system 200) to the virtually emulated traffic light apparatus.

In accordance with illustrated process block 710, autonomously controlling operation of the traffic light apparatus comprises preempting/isolating the primary traffic signal controller by linking the primary traffic signal controller to the virtually emulated traffic light apparatus.

In accordance with illustrated process block 710, the secondary traffic signal control system is operable between a second operating state and a first operating state.

In accordance with illustrated process block 710, in the second operating state the secondary traffic signal control system preempts the primary traffic signal controller from the traffic light apparatus.

In accordance with illustrated process block 710, in the second operating state the secondary traffic signal control system causes the primary traffic signal control system to control the virtually emulated traffic light apparatus.

In accordance with illustrated process block 710, in the first operating state, the secondary traffic signal control system cedes control of the traffic light apparatus to the primary traffic signal control system.

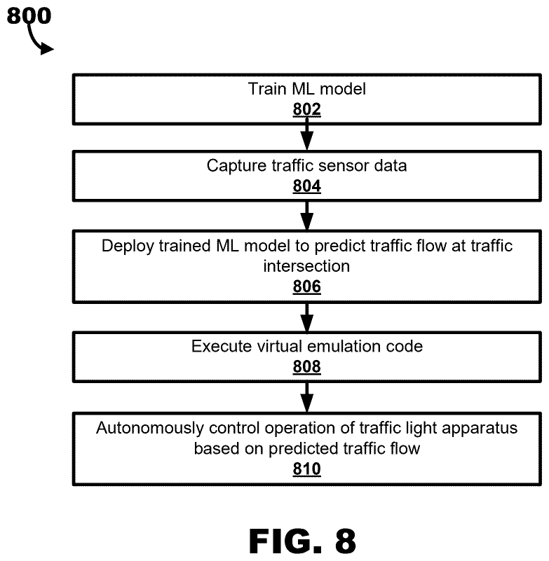

As illustrated in FIG. 8, illustrated process block 802 includes training, by a secondary traffic signal control system (e.g., secondary traffic signal control system 300) a machine learning (ML) model based on a training data set comprising traffic data to thereby obtain a trained ML model.

The computer-implemented method 800 may then proceed to illustrated process block 804, which includes capturing, by the secondary traffic signal control system, traffic sensor data at the one or more neighboring/adjacent traffic intersections (e.g., adjacent traffic intersections) located at a geographic location.

In accordance with illustrated process block 804, the traffic sensor data comprises vehicle speed data.

In accordance with illustrated process block 804, the traffic sensor data comprises image data of vehicles, pedestrians, and objects at the one or more neighboring/adjacent traffic intersections.

In accordance with illustrated process block 804, the traffic sensor data comprises vehicle identification data (e.g., vehicle license plate numbers).

The computer-implemented method 800 may then proceed to illustrated process block 806, which includes deploying, by the secondary traffic signal control system, the trained ML model to predict traffic flow at the traffic intersection based on the captured traffic sensor data.

The computer-implemented method 800 may then proceed to illustrated process block 808, which includes executing, by the secondary traffic signal control system, virtual emulation code to virtually emulate the traffic light apparatus and thereby obtain a virtually emulated traffic light apparatus.

The computer-implemented method 800 may then proceed to illustrated process block 810, which includes controlling, by the secondary traffic signal control system, the traffic light apparatus based on the predicted traffic flow.

In accordance with illustrated process block 810, autonomously controlling operation of the traffic light apparatus comprises linking a primary traffic signal controller (e.g., primary traffic signal controller 210) of a primary traffic signal control system (e.g., primary traffic signal control system 200) to the virtually emulated traffic light apparatus.

In accordance with illustrated process block 810, autonomously controlling operation of the traffic light apparatus comprises preempting/isolating the primary traffic signal controller by linking the primary traffic signal controller to the virtually emulated traffic light apparatus.

In accordance with illustrated process block 810, the secondary traffic signal control system is operable between a second operating state and a first operating state.

In accordance with illustrated process block 810, in the second operating state the secondary traffic signal control system preempts the primary traffic signal controller from the traffic light apparatus.

In accordance with illustrated process block 810, in the second operating state the secondary traffic signal control system causes the primary traffic signal control system to control the virtually emulated traffic light apparatus.

In accordance with illustrated process block 810, in the first operating state, the secondary traffic signal control system cedes control of the traffic light apparatus to the primary traffic signal control system.

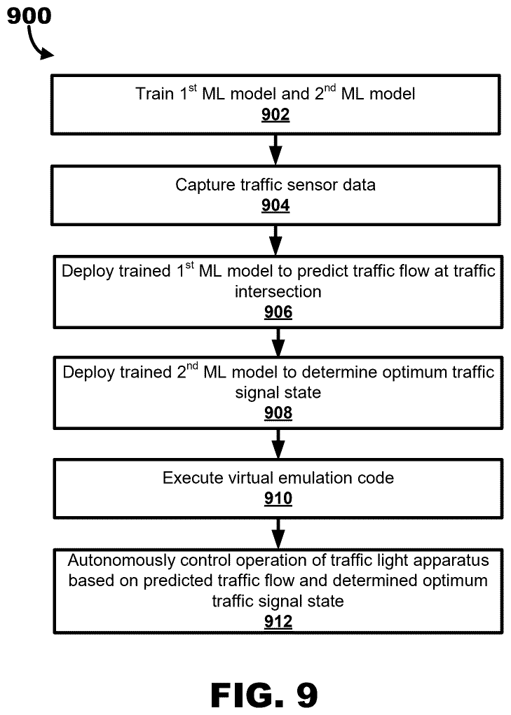

As illustrated in FIG. 9, illustrated process block 902 includes training, by a secondary traffic signal control system (e.g., secondary traffic signal control system 300) a first machine learning (ML) model and a second machine learning (ML) model based on a training data set comprising traffic data to thereby obtain a trained first ML model and a trained second ML model.

The computer-implemented method 900 may then proceed to illustrated process block 904, which includes capturing, by the secondary traffic signal control system, traffic sensor data at the one or more neighboring/adjacent traffic intersections (e.g., adjacent traffic intersections) located at a geographic location.

In accordance with illustrated process block 904, the traffic sensor data comprises vehicle speed data.

In accordance with illustrated process block 904, the traffic sensor data comprises image data of vehicles, pedestrians, and objects at the one or more neighboring/adjacent traffic intersections.

In accordance with illustrated process block 904, the traffic sensor data comprises vehicle identification data (e.g., vehicle license plate numbers).

The computer-implemented method 900 may then proceed to illustrated process block 906, which includes deploying, by the secondary traffic signal control system, the trained first ML model to predict traffic flow at the traffic intersection based on the captured traffic sensor data.

The computer-implemented method 900 may then proceed to illustrated process block 908, which includes deploying, by the secondary traffic signal control system, the trained second ML model to determine an optimum traffic signal state at the traffic intersection based on the captured traffic sensor data.

The computer-implemented method 900 may then proceed to illustrated process block 910, which includes executing, by the secondary traffic signal control system, virtual emulation code to virtually emulate the traffic light apparatus and thereby obtain a virtually emulated traffic light apparatus.

The computer-implemented method 900 may then proceed to illustrated process block 912, which includes controlling, by the secondary traffic signal control system, the traffic light apparatus based on the predicted traffic flow and the determined an optimum traffic signal state.

In accordance with illustrated process block 912, autonomously controlling operation of the traffic light apparatus comprises linking a primary traffic signal controller (e.g., primary traffic signal controller 210) of a primary traffic signal control system (e.g., primary traffic signal control system 200) to the virtually emulated traffic light apparatus.

In accordance with illustrated process block 912, autonomously controlling operation of the traffic light apparatus comprises preempting/isolating the primary traffic signal controller by linking the primary traffic signal controller to the virtually emulated traffic light apparatus.

In accordance with illustrated process block 912, the secondary traffic signal control system is operable between a second operating state and a first operating state.

In accordance with illustrated process block 912, in the second operating state the secondary traffic signal control system preempts the primary traffic signal controller from the traffic light apparatus.

In accordance with illustrated process block 912, in the second operating state the secondary traffic signal control system causes the primary traffic signal control system to control the virtually emulated traffic light apparatus.

In accordance with illustrated process block 912, in the first operating state, the secondary traffic signal control system cedes control of the traffic light apparatus to the primary traffic signal control system.

In accordance with one or more embodiments set forth, described, and/or illustrated herein, the enterprise client device 100 and the enterprise server computing system 200 could function in a fully virtualized environment. A virtual machine is where all hardware is virtual and operation is run over a virtual processor. The benefits of computer virtualization have been recognized as greatly increasing the computational efficiency and flexibility of a computing hardware platform. For example, computer virtualization facilitates multiple virtual computing machines to execute on a common computing hardware platform. Similar to a physical computing hardware platform, virtual computing machines include storage media, such as virtual hard disks, virtual processors, and other system components associated with a computing environment. For example, a virtual hard disk can store the operating system, data, and application files for a virtual machine. Virtualized computer system includes computing device or physical hardware platform, virtualization software running on hardware platform, and one or more virtual machines running on hardware platform by way of virtualization software. Virtualization software is therefore logically interposed between the physical hardware of hardware platform and guest system software running “in” virtual machine.

Memory of the hardware platform may store virtualization software and guest system software running in virtual machine. Virtualization software performs system resource management and virtual machine emulation. Virtual machine emulation may be performed by a virtual machine monitor (VMM) component. In typical implementations, each virtual machine (only one shown) has a corresponding VMM instance. Depending on implementation, virtualization software may be unhosted or hosted. Unhosted virtualization software generally relies on a specialized virtualization kernel for managing system resources, whereas hosted virtualization software relies on a commodity operating system: the “host operating system,” such as Windows or Linux to manage system resources. In a hosted virtualization system, the host operating system may be considered as part of virtualization software.

The system and method described herein may be at least partially processor-implemented, the one or more processors 310a, 310b being representative examples of hardware. For example, at least some of the operations of the computer-implemented methods may be performed by the one or more processors 310a and/or the one or more processors 310b or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors 310a, 310b, not only residing within a single machine, but deployed across a plurality of machines. In some example embodiments, the one or more processors 310a, 310b or processor-implemented modules may be located in a single geographic location (e.g., within a home environment, an office environment, or a server farm). In other example embodiments, the one or more processors or processor-implemented modules may be distributed across a plurality of geographic locations.

Devices that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for long period of time (e.g. weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A traffic control management system, comprising:
a secondary traffic signal control system operable to control operation of a traffic light apparatus, the secondary traffic signal control system including one or more processors and a non-transitory memory coupled to the one or more processors, the non-transitory memory including a set of instructions, which when executed by the one or more processors, cause the one or more processors to perform operations including:
training a machine learning (ML) model based on a training data set comprising traffic data to thereby obtain a trained ML model,
capturing traffic sensor data at one or more neighboring traffic intersections,
deploying the trained ML model to determine an optimum traffic signal state at a traffic intersection among the one or more neighboring traffic intersections based on the captured traffic sensor data,
executing virtual emulation code to virtually emulate the traffic light apparatus and thereby obtain a virtually emulated traffic light apparatus, and
autonomously controlling operation of a traffic light apparatus based on the determined optimum traffic signal state by linking a primary traffic signal controller of a primary traffic signal control system to the virtually emulated traffic light apparatus.

2. The traffic control management system of claim 1, wherein autonomously controlling operation of the traffic light apparatus comprises preempting the primary traffic signal controller via the linking of the primary traffic signal controller to the virtually emulated traffic light apparatus.

3. The traffic control management system of claim 1, further comprising a sensor module operable to dynamically detect, as the traffic sensor data, vehicle traffic and objects at the one or more neighboring traffic intersections.

4. The traffic control management system of claim 3, wherein the traffic sensor data comprises vehicle speed data and image data of vehicles, pedestrians, and objects at the one or more neighboring traffic intersections.

5. The traffic control management system of claim 1, wherein the secondary traffic signal control system is operable between a second operating state and a first operating state.

6. The traffic control management system of claim 5, wherein in the second operating state the secondary traffic signal control system is operable to:
preempt the primary traffic signal controller from the traffic light apparatus, and
cause the primary traffic signal control system to control the virtually emulated traffic light apparatus during the preemption.

7. The traffic control management system of claim 5, wherein in the first operating state, the secondary traffic signal control system is operable to cede control of the traffic light apparatus to the primary traffic signal control system.

8. A computer program product comprising at least one non-transitory computer readable medium having with a set of instructions of computer-executable program code, which when executed by one or more processors of a secondary traffic signal control system, cause the one or more processors to perform operations comprising:
training a machine learning (ML) model based on a training data set comprising traffic data to thereby obtain a trained ML model;
capturing traffic sensor data at one or more neighboring traffic intersections;
deploying the trained ML model to determine an optimum traffic signal state at a traffic intersection among the one or more neighboring traffic intersections based on the captured traffic sensor data;
executing virtual emulation code to virtually emulate the traffic light apparatus and thereby obtain a virtually emulated traffic light apparatus; and
autonomously controlling operation of a traffic light apparatus based on the determined optimum traffic signal state by linking a primary traffic signal controller of a primary traffic signal control system to the virtually emulated traffic light apparatus.

9. The computer program product of claim 8, wherein autonomously controlling operation of the traffic light apparatus comprises preempting the primary traffic signal controller via the linking of the primary traffic signal controller to the virtually emulated traffic light apparatus.

10. The computer program product of claim 8, further comprising a sensor module operable to dynamically detect, as the traffic sensor data, vehicle traffic and objects at the one or more neighboring traffic intersections.

11. The computer program product of claim 10, wherein the traffic sensor data comprises vehicle speed data and image data of vehicles, pedestrians, and objects at the one or more neighboring traffic intersections.

12. The computer program product of claim 8, wherein the secondary traffic signal control system is operable between a second operating state and a first operating state.

13. The computer program product of claim 12, wherein in the second operating state the secondary traffic signal control system:
preempts the primary traffic signal controller from the traffic light apparatus, and
causes the primary traffic signal control system to control the virtually emulated traffic light apparatus during the preemption.

14. The computer program product of claim 12, wherein in the first operating state, the secondary traffic signal control system is operable to cede control of the traffic light apparatus to the primary traffic signal control system.

15. A computer-implemented method for controlling a traffic signal traffic light apparatus mounted at a traffic intersection located at a geographic location having one or more neighboring/adjacent traffic intersections, the computer-implemented method comprising:
training, by a secondary traffic signal control system, a machine learning (ML) model based on a training data set comprising traffic data to thereby obtain a trained ML model;
capturing, by the secondary traffic signal control system, traffic sensor data at one or more neighboring traffic intersections;
deploying, by the secondary traffic signal control system, the trained ML model to determine an optimum traffic signal state at a traffic intersection among the one or more neighboring traffic intersections based on the captured traffic sensor data;
executing, by the secondary traffic signal control system, virtual emulation code to virtually emulate the traffic light apparatus and thereby obtain a virtually emulated traffic light apparatus; and
autonomously controlling, by the secondary traffic signal control system, operation of a traffic light apparatus based on the predicted traffic flow and the determined optimum traffic signal state by linking a primary traffic signal controller of a primary traffic signal control system to the virtually emulated traffic light apparatus.

16. The computer-implemented method of claim 15, wherein autonomously controlling operation of the traffic light apparatus comprises preempting the primary traffic signal controller via the linking of the primary traffic signal controller to the virtually emulated traffic light apparatus.

17. The computer-implemented method of claim 15, wherein the traffic sensor data comprises vehicle speed data and image data of vehicles, pedestrians, and objects at the one or more neighboring/adjacent traffic intersections.

18. The computer-implemented method of claim 15, wherein the secondary traffic signal control system is operable between a second operating state and a first operating state.

19. The computer-implemented method of claim 18, wherein in the second operating state the secondary traffic signal control system:
preempts the primary traffic signal controller from the traffic light apparatus, and
causes the primary traffic signal control system to control the virtually emulated traffic light apparatus during the preemption.

20. The computer-implemented method of claim 18, wherein in the first operating state, the secondary traffic signal control system is operable to cede control of the traffic light apparatus to the primary traffic signal control system.
